(19) United States
(12) Patent Application Publication
(10) Pub. No.: US 2026/0225082 A1
(43) Pub. Date: Aug. 6, 2026

(54) CATALYST FOR SYNTHESIZING AMMONIA SHOWING HIGH ACTIVITY UNDER LOW PRESSURE AND LOW TEMPERATURE CONDITIONS AND METHOD OF SYNTHESIZING AMMONIA USING THE SAME

(71) Applicant: KOREA INSTITUTE OF ENERGY RESEARCH, Daejeon (KR)

(72) Inventors: KangHee CHO, Daejeon (KR); Hyung-chul YOON, Daejeon (KR); Sun Hyung KIM, Daejeon (KR); Hyung Kuk JU, Jeonju-si (KR); Hee-tae BEUM, Daejeon (KR); Sang-goo JEON, Daejeon (KR); Ki Bong LEE, Seoul (KR)

(73) Assignee: KOREA INSTITUTE OF ENERGY RESEARCH, Daejeon (KR)

(21) Appl. No.: 19/157,404

(22) PCT Filed: May 4, 2023
(86) PCT No.: PCT/KR2023/006166

§ 371 Date: Aug. 18, 2025

(51) Int. Cl. B01J 23/58; B01J 23/00; B01J 23/02; B01J 37/02; B01J 37/08; C01C 1/04

(52) U.S. Cl. CPC B01J 23/58; B01J 23/007; B01J 23/02; B01J 37/0228; B01J 37/086; C01C 1/0411

(57) ABSTRACT

Provided are a catalyst for synthesizing ammonia including a cocatalyst and a method of synthesizing ammonia using the same. According to the catalyst material and the method of preparing the same of the present invention, ammonia may be synthesized with high efficiency at lower temperature and pressure than those of the conventional commercial Haber-Bosch process, and thus, process energy consumption and carbon dioxide emission are greatly lowered.

### CROSS REFERENCE TO RELATED APPLICATIONS

This application is the National Phase of PCT International Application No. PCT/KR2023/006166, filed on May 4, 2023, which is hereby expressly incorporated by reference into the present application.

### TECHNICAL FIELD

The present invention relates to a catalyst for synthesizing ammonia showing high activity under low pressure and low temperature conditions and a method of synthesizing ammonia using the same.

### BACKGROUND ART

Ammonia which is a compound composed of nitrogen and oxygen has a molecular formula of NH₃ and is present in a gaseous state with a pungent odor at room temperature. It is included in a small amount in the air, included in a trace amount in natural water, and also, may be produced and exist during a process of decomposing nitrogenous organic materials by bacteria in the soil. Ammonia is used as a raw material of various chemical industries, for manufacture of ammonia water, and as a solvent for ionic materials.

The most common method of preparing ammonia is a Haber-Bosch process performing synthesis from hydrogen and nitrogen, which is performed under high pressure (200 atm or higher) at a high temperature (400-500° C.) in the presence of an iron or ruthenium catalyst. The reaction consumes a huge amount of energy of about 30 GJ/ton NH₃, and greenhouse gases in a large amount corresponding to 1.8 ton CO₂/ton NH₃ are emitted due to fossil fuels used for energy supply. In addition, catalytic activity may be hindered by the characteristic in which nitrogen and hydrogen molecules are adsorbed competitively on a catalytic surface, and nitrogen of the reactants has a very stable structure of a triple bond. Thus, an ammonia synthesis rate by a catalytic reaction is generally only 20%.

In addition, in order to meet a hydrogen supply amount (5.26 million tons/yr) by 2040 for realization of a hydrogen economy society, the government was planning to procure at least 10-50% of the target supply amount of green hydrogen from overseas at low cost after 2030, but when the green hydrogen is pressurized and liquefied for long distance transport, energy density is still low and hydrogen loss and energy consumption are high during transportation, and thus, it is difficult to secure price competitiveness. However, since ammonia has high hydrogen storage density, is easily liquefied, and is evaluated as the most appropriate hydrogen storage and transport medium, a technology to convert overseas green hydrogen into ammonia and store and transport it is needed.

Thus, energy consumption has been decreased to a level of 28 GJ/ton NH₃, which is close to a theoretical value by many technology developments and optimization of a Haber-Bosch process. However, since energy required for ammonia synthesis is further reduced for reducing production costs and conventional commercial catalysts are designed to be operated under high temperature and high pressure conditions, ammonia synthesis performance is very low under the low pressure and low temperature conditions to be desired, and thus, a groundbreaking catalyst which sufficiently allows ammonia synthesis under a pressure (100 atm or lower) and a temperature (400° C. or lower) which are significantly lower than conventional process conditions (400-500° C., 200 atm or higher) should be developed and used.

### DISCLOSURE

### Technical Problem

An object of the present invention is to provide a novel catalyst material which shows a significantly higher ammonia synthesis rate than conventional commercial ammonia synthesis catalysts at a lower pressure (less than 100 atm) and a lower temperature (400° C.) than those in a conventional Haber-Bosch process which produces ammonia, and a method of preparing the catalyst.

### Technical Solution

In one general aspect, a catalyst for synthesizing ammonia comprises: a support on which a first metal catalyst is supported; and a second metal cocatalyst which is further supported on the support on which the first metal catalyst is supported.

In the catalyst for synthesizing ammonia of the present invention, the support may be one selected from the group consisting of Al₂O₃, SiO₂, Fe₂O₃, MgO, CeO₂, TiO₂, Zro₂, V₂O₅, Cr₂O₃, Sm₂O₃, and La₂O₃, and a surface of the support may be coated with a carbon component.

In the catalyst for synthesizing ammonia of the present invention, the first metal may be one selected from the group consisting of iron (Fe), ruthenium (Ru), cobalt (Co), nickel (Ni), and osmium (Os), and the first metal catalyst may be included at 1 to 20 wt % with respect to the mass of the support.

In the catalyst for synthesizing ammonia of the present invention, the second metal may be one selected from the group consisting of lithium (Li), sodium (Na), potassium (K), rubidium (Rb), cesium (Cs), beryllium (Be), magnesium (Mg), calcium (Ca), strontium (Sr), and barium (Ba), and the second metal cocatalyst may be included at 0.1 to 3 mmol/g with respect to the mass of the support.

In another general aspect, a method of synthesizing ammonia using the catalyst for synthesizing ammonia comprises: synthesizing ammonia at a temperature of 300 to 400° C. and a pressure of 10 to 100 atm.

In still another general aspect, a method of preparing a catalyst for synthesizing ammonia comprises: (a) supporting a first metal catalyst on a support; and (b) supporting a second metal cocatalyst on the support on which the first metal catalyst is supported, and comprises: (a) supporting a second metal cocatalyst on a support; and (b) supporting a first metal catalyst on the support on which the second metal cocatalyst is supported.

In the method of preparing a catalyst for synthesizing ammonia of the present invention, the support may be one selected from the group consisting of Al₂O₃, SiO₂, Fe₂O₃, MgO, CeO₂, TiO₂, ZrO₂, V₂O₅, Cr₂O₃, Sm₂O₃, and La₂O₃.

In the method of preparing a catalyst for synthesizing ammonia of the present invention, the first metal may be one selected from the group consisting of iron (Fe), ruthenium (Ru), cobalt (Co), nickel (Ni), and osmium (Os), and the first metal catalyst may be included at 1 to 20 wt % with respect to the mass of the support.

In the method of preparing a catalyst for synthesizing ammonia of the present invention, the second metal may be one selected from the group consisting of lithium (Li), sodium (Na), potassium (K), rubidium (Rb), cesium (Cs), beryllium (Be), magnesium (Mg), calcium (Ca), strontium (Sr), and barium (Ba), and the second metal cocatalyst may be included at 0.1 to 3 mmol/g with respect to the mass of the support.

### Advantageous Effects

According to the catalyst material and the method of preparing the same of the present invention, ammonia may be synthesized with high efficiency at lower temperature and pressure than those of the conventional commercial Haber-Bosch process, and thus, process energy consumption and carbon dioxide emission may be greatly lowered.

### DESCRIPTION OF DRAWINGS

The above and other objects, features and advantages of the present invention will become apparent from the following description of preferred embodiments given in conjunction with the accompanying drawings, in which:

FIG. 1 is an XRD graph of the catalyst for synthesizing ammonia according to the present invention, and

FIG. 2 is an SEM image of the catalyst for synthesizing ammonia according to the present invention.

### BEST MODE

Hereinafter, the catalyst for preparing ammonia of the present invention will be described in detail with reference to the accompanying drawings.

The drawings to be provided below are provided by way of example so that the spirit of the present invention can be sufficiently transferred to a person skilled in the art to which the present invention pertains. Therefore, the present invention is not limited to the drawings provided below but may be embodied in many different forms, and the drawings suggested below may be exaggerated in order to clear the spirit of the present invention.

Technical terms and scientific terms used herein have the general meaning understood by those skilled in the art to which the present invention pertains, unless otherwise defined, and the description for the known function and configuration which may unnecessarily obscure the gist of the present invention will be omitted in the following description and the accompanying drawings.

In addition, the singular form used in the specification and claims appended thereto may be intended to include a plural form also, unless otherwise indicated in the context.

In addition, the numerical range used in the present specification comprises all values within the range including the lower limit and the upper limit, increments logically derived in a form and span of a defined range, all double limited values, and all possible combinations of the upper limit and the lower limit in the numerical range defined in different forms. Unless otherwise defined in the specification of the present invention, values which may be outside a numerical range due to experimental error or rounding off of a value are also included in the defined numerical range.

In the present specification and the appended claims, the terms such as “first” and “second” are not used in a limited meaning but are used for the purpose of distinguishing one constituent element from other constituent elements.

In the present specification and the appended claims, the terms such “comprise” or “have” mean that there is a characteristic or a constituent element described in the specification, and as long as it is not particularly limited, a possibility of adding one or more other characteristics or constituent elements is not excluded in advance.

In the present specification and the appended claims, when a portion such as a membrane (layer), a region, and a constituent element is present on another portion, not only a case in which the portion is in contact with and directly on another portion but also a case in which other membranes (layers), other regions, and other constitutional elements are interposed between the portions is included.

The catalyst for synthesizing ammonia of the present invention is characterized by including: a support on which a first metal catalyst is supported; and a second metal cocatalyst which is further supported on the support on which the first metal catalyst is supported.

In a specific example, the support may be one selected from the group consisting of Al₂O₃, SiO₂, Fe₂O₃, MgO, CeO₂, TiO₂, ZrO₂, V₂O₅, Cr₂O₃, Sm₂O₃, and La₂O₃ and may be one selected from the group consisting of a physical mixture thereof, an alloy by chemical mixing, a form in which a component is supported on a skeleton of another component, and a form in which a component is impregnated in a skeleton of another component, but it is most preferred to select Mgo or a hydrotalcite in which MgO and Al₂O₃ are mixed.

Since the support having a large specific surface area is used, the metal catalyst is highly dispersed to be small and uniform to reduce catalyst cost, sintering of the metal catalyst and the cocatalyst during long-term use is prevented, and an electron is supplied to a nitrogen molecule with the cocatalyst to promote a nitrogen dissociation step, and the dissociated nitrogen atom is bonded well to proceed with a hydrogenation reaction and promote an ammonia production step.

In a specific example, the surface of the support may be coated with a carbon component. Due to the coating with the carbon component, electrical conductivity is increased to rapidly transfer an electron to a nitrogen molecule to promote the reaction, and also the first metal catalyst or the second metal cocatalyst may be highly dispersed.

In a specific example, a non-limiting example of the first metal may include a metal selected from the group consisting of iron (Fe), ruthenium (Ru), cobalt (Co), nickel (Ni), and osmium (Os), or, may be ruthenium.

The first metal catalyst may be included at 1 to 20 wt %, or 1 to 15 wt %, or 1 to 10 wt %, with respect to the mass of the support.

The first metal catalyst may have an average particle diameter of 0.1 to 50 nm, or 0.1 to 20 nm, or 0.1 to 5 nm. When the first metal catalyst has the average particle diameter in the range, a reaction point exposed to a surface area is increased to increase synthesis performance per unit mass of the first metal, and the amount of the first metal used is decreased as the synthesis performance is increased, thereby reducing catalyst cost.

In a specific example, the second metal may be an alkali metal or an alkaline earth metal, and a non-limiting example of the second metal may include a metal selected from the group consisting of lithium (Li), sodium (Na), potassium (K), rubidium (Rb), cesium (Cs), beryllium (Be), magnesium (Mg), calcium (Ca), strontium (Sr), and barium (Ba), or, may be barium.

The second metal cocatalyst may be included at 0.1 to 3 mmol/g, or 0.3 to 2.5 mmol/g, or 0.5 to 2.0 mmol/g, with respect to the mass of the support.

Due to the additional support of the second metal cocatalyst, an electron is supplied to nitrogen which is a reactant of an ammonia synthesis reaction (Lewis base), thereby weakening a nitrogen binding force and increasing a reaction rate of a nitrogen dissociation step (rate determining step of the entire reaction) to proceed with the reaction in a forward direction.

In a specific example, the catalyst for synthesizing ammonia has an average particle diameter of 1 to 1,000 μm, or 2 to 900 μm, or 3 to 800 μm, but is not limited thereto.

In addition, a specific surface area of the catalyst for synthesizing ammonia by BET measurement may be 10 to 200 m²/g, or 20 to 180 m²/g, or 30 to 150 m²/g. A nitrogen molecule may be easily adsorbed on the surface of the catalyst by the catalyst for synthesizing ammonia having the average particle diameter and the specific surface area.

A method of synthesizing ammonia using the catalyst for synthesizing ammonia of the present invention is characterized by synthesizing ammonia at a temperature of 300 to 400° C. and a pressure of 10 to 100 atm.

The most common method of preparing ammonia is a Haber-Bosch process performing synthesis from hydrogen and nitrogen, which is performed under high pressure (200 atm or higher) at a high temperature (400-500° C.) in the presence of a catalyst. The reaction consumes a huge amount of energy and emits a large amount of greenhouse gas, catalytic activity may be hindered by the characteristic in which nitrogen and hydrogen molecules are adsorbed competitively on a catalytic surface, and nitrogen of the reactants has a very stable structure of a triple bond. Thus, an ammonia synthesis rate by a catalytic reaction is generally only 20%.

However, since the method of synthesizing ammonia using the catalyst for synthesizing ammonia of the present invention shows a higher ammonia synthesis rate than conventional commercial catalysts for synthesizing ammonia at lower pressure and lower temperature than those of the Haber-Bosch process, the process energy consumption and carbon dioxide emission may be greatly lowered.

The method of preparing the catalyst for synthesizing ammonia of the present invention may include: (a) supporting a first metal catalyst on a support; and (b) supporting a second metal cocatalyst on the support on which the first metal catalyst is supported. In addition, the method may include (a) supporting a second metal cocatalyst on a support; and (b) supporting a first metal catalyst on the support on which the second metal cocatalyst is supported.

In a specific example, the support may be one selected from the group consisting of Al₂O₃, SiO₂, Fe₂O₃, MgO, CeO₂, TiO₂, ZrO₂, V₂O₅, Cr₂O₃, Sm₂O₃, and La₂O₃ and may be one selected from the group consisting of a physical mixture thereof, an alloy by chemical mixing, a form in which a component is supported on a skeleton of another component, and a form in which a component is impregnated in a skeleton of another component, but it is most preferred to select MgO or a hydrotalcite in which MgO and Al₂O₃ are mixed.

In a specific example, a method of supporting the first metal catalyst may use a method of dissolving a first metal catalyst precursor in an appropriate solvent (water, alcohols, acetone, THF, DMF), impregnating the precursor in a support by an incipient wetness impregnation method or a wetness impregnation method, and drying the solvent and performing a reduction treatment, or use a vapor deposition method, but the method is not particularly limited as long as it is a common supporting method.

In a specific example, in the method of supporting the first metal catalyst, the first metal may be one selected from the group consisting of iron (Fe), ruthenium (Ru), cobalt (Co), nickel (Ni), and osmium (Os), or may be ruthenium, in which a precursor of the ruthenium catalyst may be a ruthenium metal, ruthenium oxide (RuO₂), ruthenium red, ruthenium acetylacetonate (Ru(acac)₃), ruthenium chloride (RuCl₃), ruthenocene (bis(cyclopentadienyl) ruthenium), ruthenium nitrosyl nitrate, ruthenium iodide (RuI₃), triruthenium dodecacarbonyl (Ru₃(CO)₁₂), ruthenium nitrate (Ru(NO₃)₃), and the like, but is not limited thereto. Herein, the first metal catalyst may be included at 1 to 20 wt %, or 1 to 15 wt %, or 1 to 10 wt %, with respect to the mass of the support.

In a specific example, before supporting the first metal catalyst, the first metal catalyst may be further pretreated. The pretreatment is heating and sintering while flowing inert gas such as nitrogen, argon, and helium or ammonia reaction synthesis gas (H₂+N₂), and reducing gas such as hydrogen, diluted hydrogen (balance gas: inert gas such as nitrogen, argon, and hydrogen), carbon monoxide, and diluted carbon monoxide (balance gas: inert gas such as nitrogen, argon, and hydrogen), and a heating temperature depends on the components of the first metal, but may be 250 to 700° C.

In a specific example, a method of supporting the second metal cocatalyst may use a method of dissolving a second metal cocatalyst precursor in an appropriate solvent (water, alcohols, acetone, THF, DMF), impregnating the precursor in a support by an incipient wetness impregnation method or a wetness impregnation method, and drying the solvent and performing a reduction treatment, or use a vapor deposition method, but the method is not particularly limited as long as it is a common supporting method.

In a specific example, in the method of supporting the second metal cocatalyst, the second metal may be one selected from the group consisting of lithium (Li), sodium (Na), potassium (K), rubidium (Rb), cesium (Cs), beryllium (Be), magnesium (Mg), calcium (Ca), strontium (Sr), and barium (Ba), or, may be barium, in which a barium cocatalyst precursor may be barium nitrate (Ba(NO₃)₂), barium hydroxide (Ba(OH)₂), barium perchlorate (Ba(ClO₄)₂), barium isopropoxide (Ba(OCH(CH₃)₂)₂), barium fluoride (BaF₂), barium oxide (BaO), barium bromide (BaBr₂), barium chloride (BaCl₂), barium iodide (Bal₂), barium acetate (Ba(CH₃COO)₂), barium carbonate (BaCO₃), barium sulfate (BaSO₄), and the like, but is not limited thereto. Herein, the second metal cocatalyst may be included at 0.1 to 3 mmol/g, or 0.3 to 2.5 mmol/g, or 0.5 to 2.0 mmol/g, with respect to the mass of the support.

In a specific example, before supporting the second metal cocatalyst, the second metal cocatalyst may be further pretreated. The pretreatment is heating and sintering while flowing inert gas such as nitrogen, argon, and helium or ammonia reaction synthesis gas (H₂+N₂), and reducing gas such as hydrogen, diluted hydrogen (balance gas: inert gas such as nitrogen, argon, and hydrogen), carbon monoxide, and diluted carbon monoxide (balance gas: inert gas such as nitrogen, argon, and hydrogen), and a heating temperature depends on the components of the first metal, but may be 250 to 700° C.

Hereinafter, the present invention will be described in detail by the examples. However, the examples are for describing the present invention in more detail, and the scope of the present invention is not limited to the following examples.

### <Example 1> Preparation of Catalyst for Synthesizing Ammonia

1 mmol of barium nitrate (Ba(NO₃)₂) was completely dissolved in distilled water and uniformly mixed with 1 g of a MgO-based support, and the solvent was completely removed by a drying process. Powder was recovered and heated to 500° C. under nitrogen to perform a heat treatment. A solution of 0.05 g of triruthenium dodecacarbonyl (C₁₂O₁₂RU₃) dissolved in an organic solvent was added to the heat-treated powder, stirring was performed, and a drying process was performed to remove the organic solvent.

### <Example 2> Preparation of Catalyst Having a Ruthenium Content of 9 wt %

A catalyst was prepared by the same method as the method of preparing the catalyst for synthesizing ammonia of Example 1, except that 0.09 g of C₁₂O₁₂Ru₃ was used instead of 0.05 g of C₁₂O₁₂Ru₃.

### <Example 3> Preparation of Catalyst Having a Barium Content of 0.5 Mmol/g

A catalyst was prepared by the same method as the method of preparing the catalyst for synthesizing ammonia of Example 1, except that 0.5 mmol of Ba(NO₃)₂ was used instead of 1 mmol of Ba(NO₃)₂.

### <Example 4> Preparation of Catalyst Having a Barium Content of 2.0 Mmol/g

A catalyst was prepared by the same method as the method of preparing the catalyst for synthesizing ammonia of Example 1, except that 2.0 mmol of Ba(NO₃)₂ was used instead of 1 mmol of Ba(NO₃)₂.

### <Example 5> Preparation of Catalyst Using Hydrotalcite as Support

A catalyst was prepared by the same method as the method of preparing the catalyst for synthesizing ammonia of Example 1, except that hydrotalcite was used instead of the MgO-based support.

### <Comparative Example 1> Preparation of Catalyst Including No Ruthenium

A catalyst was prepared by the same method as the method of preparing the catalyst for synthesizing ammonia of Example 1, except that C₁₂O₁₂Ru₃ was not used.

### <Comparative Example 2> Preparation of Catalyst Including No Barium

A catalyst was prepared by the same method as the method of preparing the catalyst for synthesizing ammonia of Example 1, except that Ba(NO₃)₂ was not used.

### <Example 3> Preparation of Catalyst Having a Ruthenium Content of 2 wt %

A catalyst was prepared by the same method as the method of preparing the catalyst for synthesizing ammonia of Example 1, except that 0.02 g of C₁₂O₁₂Ru₃ was used instead of 0.05 g of C₁₂O₁₂Ru₃.

### <Comparative Example 4> Preparation of Catalyst Including Cesium as Cocatalyst

A catalyst was prepared by the same method as the method of preparing the catalyst for synthesizing ammonia of Example 1, except that cesium nitrate (CsNO₃) was used instead of barium nitrate (Ba(NO₃)₂).

### <Comparative Example 5> Preparation of Catalyst Including Potassium as Cocatalyst

A catalyst was prepared by the same method as the method of preparing the catalyst for synthesizing ammonia of Example 1, except that potassium nitrate (KNO₃) was used instead of barium nitrate (Ba(NO₃)₂).

### <Comparative Example 6> Preparation of Catalyst Using SiO₂ as Support

A catalyst was prepared by the same method as the method of preparing the catalyst for synthesizing ammonia of Example 1, except that a SiO₂-based support (silica) was used instead of the MgO-based support.

### <Comparative Example 7> Preparation of Catalyst Using CeO₂ as Support

A catalyst was prepared by the same method as the method of preparing the catalyst for synthesizing ammonia of Example 1, except that a CeO₂-based support (ceria) was used instead of the MgO-based support.

### <Experimental Example 1> Analysis of Structure of Catalyst for Synthesizing Ammonia

First, the structure of the catalyst for synthesizing ammonia prepared by the preparation method of Example 1 was observed by X-ray diffraction analysis.

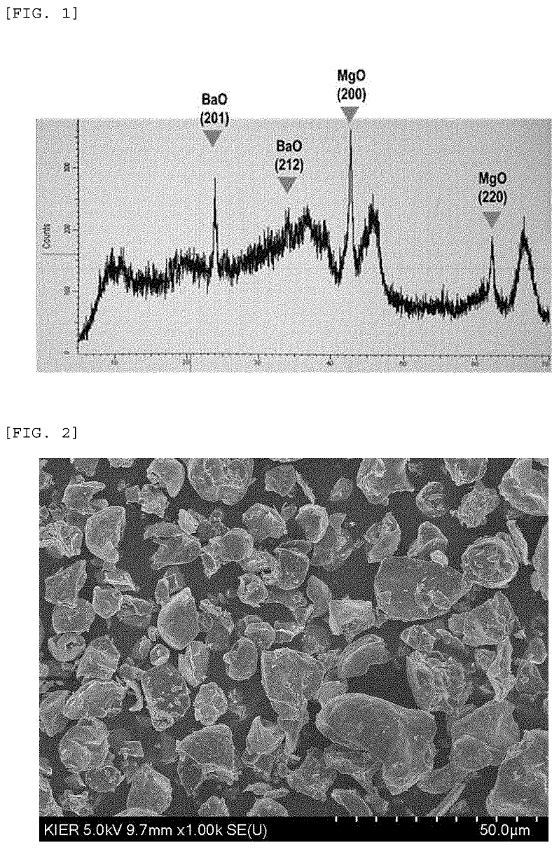

Referring to FIG. 1, a peak due to the presence of MgO crystal which is the support is shown, and a barium component used as the cocatalyst is present as an oxide form. Since barium is easily oxidized in the air, it is present as an oxide form, but it is easily oxidized by hydrogen under ammonia synthesis reaction conditions to serve as a cocatalyst. Considering that a peak of barium nitrate used as the barium precursor is not seen, it is shown that a barium nitrate precursor was converted into a barium or barium oxide form during preparation. In addition, it is difficult to observe a peak of ruthenium or an oxide form thereof, from which it is shown that ruthenium was highly dispersed in a very small size in the support.

Next, as a result of measuring a specific surface area using a nitrogen physical adsorption method, it was confirmed that the catalyst for synthesizing ammonia of Example 1 had a specific surface area of about 80 m²/g.

Finally, as a result of analyzing the catalyst for synthesizing ammonia using SEM, the catalyst was confirmed to have an average particle diameter of about 1 to 300 μm, as seen in FIG. 2.

### <Experimental Example 2> Analysis of Ammonia Synthesis Rate Using Catalyst for Synthesizing Ammonia

After synthesizing ammonia using the catalysts synthesized by the preparation methods of Examples 1 to 5 and Comparative Examples 1 to 7, ammonia synthesis rates were evaluated. Mixed gas of H₂/N₂=3 (mole ratio) was injected in a top-down manner into a high-pressure fixed bed reactor. The reaction proceeded at 50 atm and 400° C. at a reaction flow rate (GHSV) of 5,000 h⁻¹, and the results are shown in Table 1.

TABLE 1

| | | | | | | Ammonia |
|---|---|---|---|---|---|---|
| | | Catalyst | | Cocatalyst | | synthesis |
| | Catalyst | content | Cocatalyst | content | Type of | rate (g-NH₃/ |
| | component | (wt %) | component | (mmol/g) | support | g-cat · hr) |
| Example 1 | Ru | 5 | Ba | 1 | MgO | 0.8 |
| Example 2 | Ru | 9 | Ba | 1 | MgO | 0.79 |
| Example 3 | Ru | 5 | Ba | 0.5 | MgO | 0.5 |
| Example 4 | Ru | 5 | Ba | 2 | MgO | 0.5 |
| Example 5 | Ru | 5 | Ba | 1 | Hydrotalcite | 0.78 |
| Comparative | Ru | 0 | Ba | 1 | MgO | ~0 |
| Example 1 | | | | | | |
| Comparative | Ru | 5 | Ba | 0 | MgO | 0.1 |
| Example 2 | | | | | | |
| Comparative | Ru | 2 | Ba | 1 | MgO | 0.2 |
| Example 3 | | | | | | |
| Comparative | Ru | 5 | Cs | 1 | MgO | 0.3 |
| Example 4 | | | | | | |
| Comparative | Ru | 5 | K | 1 | MgO | 0.2 |
| Example 5 | | | | | | |
| Comparative | Ru | 5 | Ba | 1 | SiO₂ | 0.06 |
| Example 6 | | | | | | |
| Comparative | Ru | 5 | Ba | 1 | CeO₂ | 0.25 |
| Example 7 | | | | | | |

Referring to Table 1, it was shown that when ammonia was synthesized using the catalysts prepared by the preparation methods of Examples 1 to 5 (the type of support: MgO or hydrotalcite, first metal catalyst component: Ru, second metal cocatalyst component: Ba), the ammonia synthesis rate was excellent as compared with the catalysts prepared by the preparation methods of Comparative Examples 1 to 7. In particular, with the catalysts having the first metal catalyst content of 3 to 10 wt % and the second metal cocatalyst content of 1 mmol/g (Examples 1, 2, and 5), the ammonia synthesis rate was about 0.8 g-NH₃/g-cathr, and in general, when the ammonia synthesis rate of 0.3 g-MH₃/g-cathr or more is shown, it is a higher level than that of conventional commercial catalyst performance under the same low pressure conditions, and thus, it is shown that the ammonia synthesis rate was excellent.

In comparison, with the catalyst including no first metal catalyst as in Comparative Example 1 or the catalyst including no second metal cocatalyst as in Comparative Example 2, it was shown that ammonia was hardly synthesized under 50 atm and 400° C. conditions.

In addition, with the catalyst having a different content of the first metal catalyst as in Comparative Example 3, it was confirmed that the ammonia synthesis rate was significantly low as compared with the catalysts of Examples 1 and 2.

In addition, with the catalysts having a different cocatalyst component as in Comparative Examples 4 and 5 or the catalysts having a different type of support as in Comparative Examples 6 and 7, it was confirmed that the ammonia synthesis rate was significantly low.

As described above, the catalyst for synthesizing ammonia according to the present invention showed an excellent ammonia synthesis rate effect even under low temperature and low pressure conditions, unlike the ammonia synthesis according to a common Haber-Bosch method.

1.-15. (canceled)

16. A catalyst for synthesizing ammonia comprising:
a support on which a first metal catalyst is supported; and
a second metal cocatalyst which is further supported on the support on which the first metal catalyst is supported.

17. The catalyst for synthesizing ammonia of claim 16, wherein the support is one selected from the group consisting of Al₂O₃, SiO₂, Fe₂O₃, MgO, CeO₂, TiO₂, ZrO₂, V₂O₅, Cr₂O₃, Sm₂O₃, and La₂O₃.

18. The catalyst for synthesizing ammonia of claim 17, wherein a surface of the support is coated with a carbon component.

19. The catalyst for synthesizing ammonia of claim 16, wherein the first metal is one selected from the group consisting of iron (Fe), ruthenium (Ru), cobalt (Co), nickel (Ni), and osmium (Os).

20. The catalyst for synthesizing ammonia of claim 16, wherein the first metal catalyst is comprised at 1 to 20 wt % with respect to the mass of the support.

21. The catalyst for synthesizing ammonia of claim 16, wherein the second metal is one selected from the group consisting of lithium (Li), sodium (Na), potassium (K), rubidium (Rb), cesium (Cs), beryllium (Be), magnesium (Mg), calcium (Ca), strontium (Sr), and barium (Ba).

22. The catalyst for synthesizing ammonia of claim 16, wherein the second metal cocatalyst is comprised at 0.1 to 3 mmol/g with respect to the mass of the support.

23. A method of synthesizing ammonia at a temperature of 300 to 400° C. and a pressure of 10 to 100 atm using the catalyst for synthesizing ammonia of claim 16.

24. A method of preparing a catalyst for synthesizing ammonia, the method comprising:
(a) supporting a first metal catalyst on a support; and
(b) supporting a second metal cocatalyst on the support on which the first metal catalyst is supported.

25. The method of preparing a catalyst for synthesizing ammonia of claim 24, wherein the support is one selected from the group consisting of Al₂O₃, SiO₂, Fe₂O₃, MgO, CeO₂, TiO₂, ZrO₂, V₂O₅, Cr₂O₃, Sm₂O₃, and La₂O₃.

26. The method of preparing a catalyst for synthesizing ammonia of claim 24, wherein the first metal is one selected from the group consisting of iron (Fe), ruthenium (Ru), cobalt (Co), nickel (Ni), and osmium (Os).

27. The method of preparing a catalyst for synthesizing ammonia of claim 24, wherein the first metal catalyst is comprised at 1 to 20 wt % with respect to the mass of the support.

28. The method of preparing a catalyst for synthesizing ammonia of claim 24, wherein the second metal is one selected from the group consisting of lithium (Li), sodium (Na), potassium (K), rubidium (Rb), cesium (Cs), beryllium (Be), magnesium (Mg), calcium (Ca), strontium (Sr), and barium (Ba).

29. The method of preparing a catalyst for synthesizing ammonia of claim 24, wherein the second metal cocatalyst is comprised at 0.1 to 3 mmol/g with respect to the mass of the support.

30. A method of preparing a catalyst for synthesizing ammonia, the method comprising:
(a) supporting a second metal cocatalyst on a support; and
(b) supporting a first metal catalyst on the support on which the second metal cocatalyst is supported.

31. The method of preparing a catalyst for synthesizing ammonia of claim 30, wherein the support is one selected from the group consisting of Al₂O₃, SiO₂, Fe₂O₃, MgO, CeO₂, TiO₂, ZrO₂, V₂O₅, Cr₂O₃, Sm₂O₃, and La₂O₃.

32. The method of preparing a catalyst for synthesizing ammonia of claim 30, wherein the first metal is one selected from the group consisting of iron (Fe), ruthenium (Ru), cobalt (Co), nickel (Ni), and osmium (Os).

33. The method of preparing a catalyst for synthesizing ammonia of claim 30, wherein the first metal catalyst is comprised at 1 to 20 wt % with respect to the mass of the support.

34. The method of preparing a catalyst for synthesizing ammonia of claim 30, wherein the second metal is one selected from the group consisting of lithium (Li), sodium (Na), potassium (K), rubidium (Rb), cesium (Cs), beryllium (Be), magnesium (Mg), calcium (Ca), strontium (Sr), and barium (Ba).

35. The method of preparing a catalyst for synthesizing ammonia of claim 30, wherein the second metal cocatalyst is comprised at 0.1 to 3 mmol/g with respect to the mass of the support.
